(19) United States
(12) Patent Application Publication
(10) Pub. No.: US 2002/0074224 A1
(43) Pub. Date: Jun. 20, 2002

(54) Device for lifting the anode frame of an electrolysis cell for the production of aluminum

(75) Inventors: Gerard Piron, Lyon (FR); Serge Huon, Loffre (FR)

Correspondence Address: HESLIN ROTHENBERG FARLEY & MESITI PC, 5 COLUMBIA CIRCLE, ALBANY, NY, 12203, US

(73) Assignee: REEL SA Parc d' Activite, Sainte Consorce (FR)

(21) Appl. No.: 09/996,177

(22) Filed: Nov. 28, 2001

(30) Foreign Application Priority Data
Dec. 19, 2000 (EP) 00420261.0

(51) Int. Cl. B23H 7/26; C25C 7/00; C25B 9/00; C25D 17/04; C25D 17/16; C25D 17/06; B23H 11/00; C25F 7/00

(52) U.S. Cl. 204/297.06; 204/297.08; 204/297.09; 204/297.1; 204/297.14; 204/297.01

(57) ABSTRACT

This device for lifting the anode frame of an electrolysis cell for the production of aluminium comprises:

a horizontal cross-member (1) intended to be positioned above the cell in question;

a plurality of members for gripping and holding (5) the anode rods (12) against the anode frame, comprising:

a pressing module, pivoted (4) at its upper end to the said cross-member, so as to be able to undergo a pivoting movement with respect to the said cross-member, in such a way as to move away from the plane containing the anode rods on the same side of the cell and intended to keep the anode rods against the anode frame; and

a gripping module, fastened to the pressing module and intended to ensure actual gripping of an anode rod.

The invention relates to the field of aluminium production by igneous electrolysis, especially using the Hall-Héroult process, and more particularly to the management of certain steps in the operation of the cell-lines for such production.

The invention relates more particularly to a device for lifting the anode frame, that is to say the member carrying the various anodes within the same cell. In this case, the anodes are made of carbon sealed onto an electrically conducting metal rod.

It should be recalled that the production of aluminium using this method is carried out in electrolysis cells containing a bath of alumina dissolved in molten cryolite.

The bottom of the cells supports a cathode. Moreover, the cells have in general two conducting horizontal bars, generally called anode frames, supported by at least one height-adjustable rigid horizontal metal beam. The carbon anodes are generally positioned in two parallel rows and are supported by conducting rods removably linked to each of the two anode frames.

Thus, the anode frame, to which the anodes are fixed by means of the metal rods, steadily descends at the rate of consumption of the carbon constituting the anode, because of the chemical reaction of the electrolysis, and does so by means of a mechanism fitted to the cell.

The objective of lowering the anodes within the bath of cryolite and alumina is to keep the gap between the anode surface and the cathode approximately constant.

When the anode frame comes to the end of its vertical travel, the operation referred to as anode-frame lifting is then carried out using a tool conventionally called a lifting beam. When the cells in question do not have a particular system permanently in place for this operation, such a beam is thus moved from cell to cell.

Moreover, this anode-frame lifting operation must be carried out without interrupting the continuous process, and especially without cutting off the electric current.

Moreover, as it is necessary to maintain the anode plane, that is to say the surface defined by the set of anodes, the anodes mounted on the frame must be kept at the height that they had reached during the frame lifting operation, without thereby ceasing to be in close and intimate contact with the said frame, so as not to break the continuity of the electric current.

During this operation, it is therefore necessary, prior to the phase of actually lifting the anode frame, to disconnect the anode rods from the frame, without thereby breaking their contact with the latter.

These rods are conventionally fixed to the frame by members called connectors. These have evolved over time, for the purpose of achieving greater automation during the disconnection phases. However, the problem still remains of keeping the rod of the anode firmly in contact against the anode frame before, during and after its progress, especially during its ascent.

The invention provides a solution to this problem, which is both simple to implement and effective in its action.

This device for lifting the anode frame of an electrolysis cell for the production of aluminium comprises:

a horizontal cross-member intended to be positioned above the cell in question;

a plurality of members for gripping and holding the anode rods against the anode frame, comprising:

a pressing module, pivoted at its upper end to the said cross-member, so as to be able to undergo a pivoting movement with respect to the said cross-member, in such a way as to move away from the plane containing the anode rods on the same side of the cell and intended to keep the anode rods against the anode frame; and

a gripping module, fastened to the pressing module and intended to ensure actual gripping of an anode rod.

According to the invention, the gripping and holding members are placed on each side of the cell, and therefore on each side of the cross-member.

They are fixed to the latter with a spacing depending on the standard separation between the anode rods of a cell-line in question.

According to one characteristic of the invention, the pivoting movement of the pressing modules is provided by means of an activator, and especially an air cylinder, in the absence of the activation of which a return spring causes the said pressing modules to be pressed against the cross-member, that is to say precluding any pivoting movement, and consequently causing the anode rods to be pressed against the anode frame.

According to another characteristic of the invention, the gripping module consists of a clamp located at the lower end of the gripping and holding member, the said clamp being opened by the action of an activator, and especially air cylinder, in the absence of the activation of which a spring causes it to close onto the said anode rod.

According to another characteristic of the invention, the gripping module is capable of undergoing pivoting movements, but this time in the plane of the anode rods on the same side of the cell.

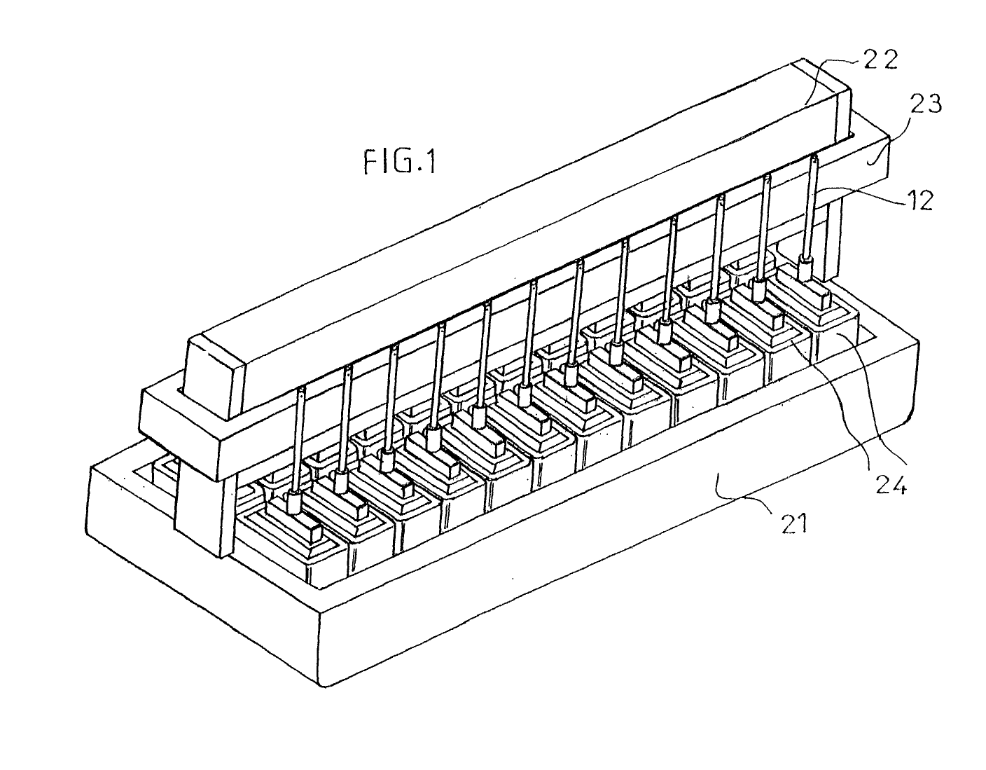

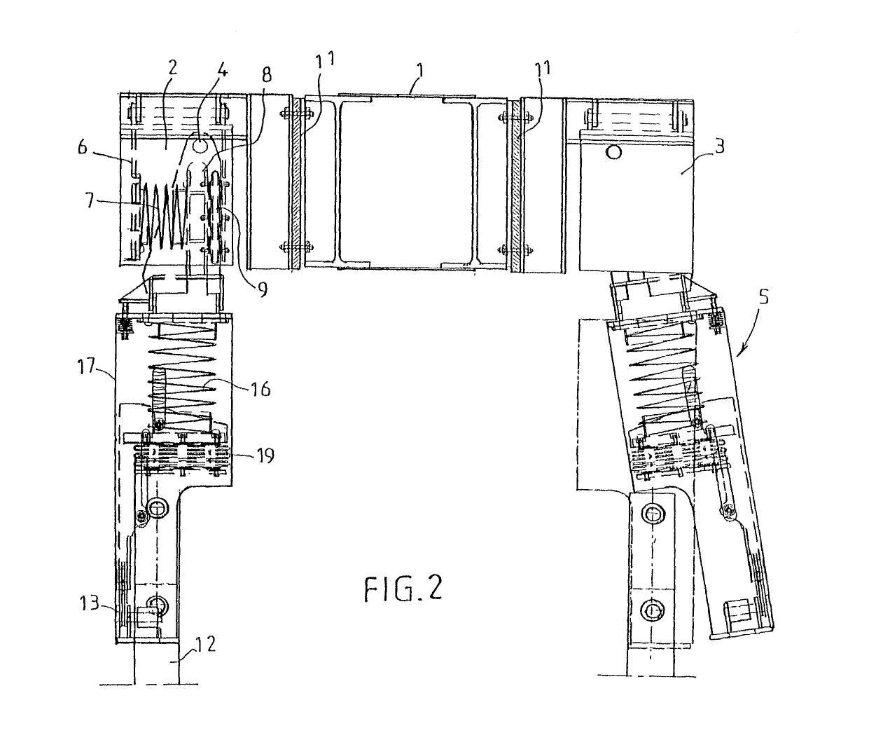

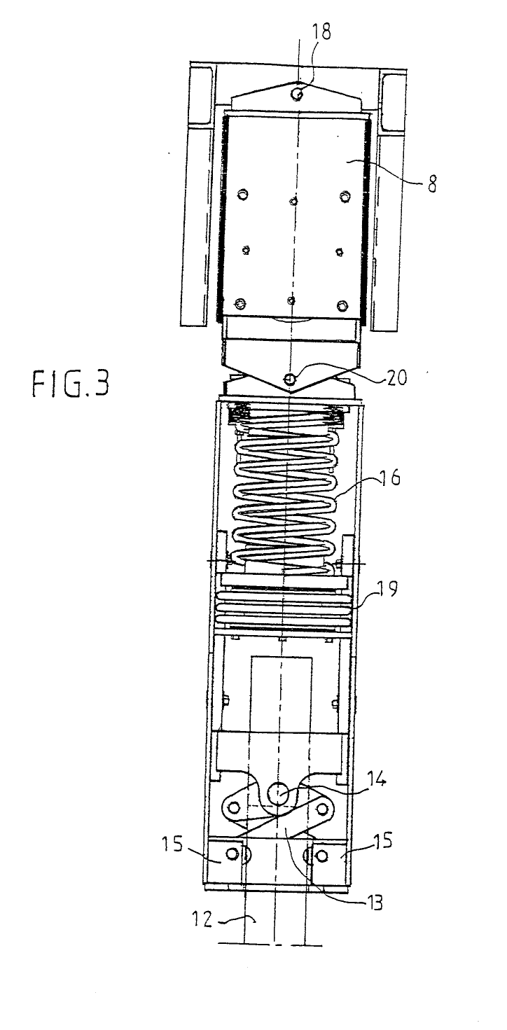

The manner in which the invention is carried out and the advantages which stem therefrom will become more clearly apparent from the exemplary embodiment which follows, given by way of indication but implying no limitation, and supported by the appended figures. FIG. 1 is a schematic representation illustrating anodes in the cell, these being fixed to the anode frame. FIG. 2 is a schematic cross-sectional representation of the device according to the invention. FIG. 3 is a representation, in side view, of the device shown in FIG. 2.

FIG. 1 shows an igneous electrolysis cell (21) within which a series of anodes (24) is immersed. These anodes are electrically connected to the anode frame (23) via an approximately vertical conducting rod (12), which furthermore fulfils the function of holding the anodes in place.

The anode frame (23) is capable of undergoing a vertical translational movement with respect to a framework (22) extending over the top of the cell. During this translational movement, by means of an anode-frame lifting beam (not shown), the anode frame pulls up the anodes (24) which are fastened to it.

FIG. 2 shows the device according to the invention. Basically this consists of an approximately symmetrical cross-member (1) intended to be positioned above each of the electrolysis cells. This cross-member is, for example, moved from one cell to another by means of one or two lifting carriages, with which the overhead cranes in the aluminium production cell-lines are equipped.

This cross-member (1) has, at both its ends, regions (2) and (3) for the articulation of a plurality of members (5) for gripping and holding the anode rods.

According to the invention, there are as many gripping members (5) as there are anodes and thus, as may be seen in FIG. 2, these gripping members are distributed on each side of the cell.

This cross-member (1), intended to rest against the cell, is electrically insulated from the gripping members (5) by means of intermediate elements (11) made of an insulating material, typically polytetrafluoroethylene (Teflon—registered trade mark).

According to a first characteristic of the invention, the gripping members (5) firstly comprise a pressing module, capable of undergoing a partial rotational movement with respect to the pivot pin (4), in a plane perpendicular to the plane containing the anode rods on the same side of the cell.

Thus, on the right-hand side of FIG. 2, a gripping member has been shown in the extreme position of its angular travel with respect to the vertical, and therefore in the absence of any function of clamping the rods against the anode frame.

Nevertheless, in the absence of any external stress, the pressing module is kept vertical by means of a prestressed spring (7) bearing respectively against the external wall (6) of the respective regions (2) and (3) and against the linking piece (8) joining the pivot pin (4) of the actual gripping member (5) The movement of the said module away from its vertical position is provided by means of an air cylinder of the soft pancake cylinder type (9), bearing against the internal partition (10) of the respective regions (2) and (3) and against the linking piece (8), as may be clearly seen in FIG. 2.

In other words, in order to actuate the pressing module with respect to its pivot pin (4), a dual-action technique is employed, using the spring (7) and the pneumatic cylinder (9) respectively, thereby making it possible to optimize safety during the operation. This is because the mechanical effect of the spring automatically provides the pressing force for clamping the anode rod against the anode frame in the absence of any external stress, such as that exerted by the cylinder. Thus, in the natural state, the anode rod is automatically held in intimate contact with the anode frame. The cylinder (9) exerts an opposing force with respect to the spring (7), thus cancelling out the pressing and clamping force exerted by the latter. This set of two opposing elements therefore makes it possible to fit the pressing module onto the anode rods and to remove it therefrom, and therefore allows effective operation of the lifting beam.

This is because fitting the lifting beam requires having to move the pressing modules aside, as shown in the right-hand part in FIG. 2, in order to allow access to the anode rods (12).

The module for gripping the anode rods (12) consists of a clamp (13), the two parts of which are pivoted at (14) in such a way as to allow the gripping regions (15) of the clamp to move closer to each other, and therefore to fulfil the function of clamping and gripping the rods (12).

In the absence of external stresses, a vertically acting spring (16), incorporated into the body (17) of the gripping member (5), ensures that the gripping members (15) are close together and therefore that the clamp (13) is held in the clamping position.

An air cylinder (19), of trilobate pancake type, of a model similar to the cylinder (9), provides the opposing force and compresses the spring, and hence opens the clamp (13) when it is actuated.

Thus, and as in the previous case, once again the the operating safety is optimized since it is the positive mechanical force of the spring (16) which provides the forces for pressing and clamping onto the anode rods (12), the cylinder (19) in this case having merely the purpose of cancelling this pressing and clamping force out when it is desired to move the anode-frame lifting device to another cell.

The particular construction of the device according to the invention, and especially the position of the actuators above the anode rods (12), makes it possible to expose the four lateral faces of the member (5), which thus releases the mechanism from the geometrical stresses to the right and to the left of each of the actuators, these stresses being imposed by the supplies of positive rise (of the electric current) at the anode frame. Correspondingly, this construction allows two complementary functions to be implemented in order to improve the electrical contact between anode rod and anode frame, the operation of which takes place just before the connectors are unclamped and just after the connectors are clamped, ensuring, as already mentioned, that the rods are fastened to the anode frame.

The device according to the invention therefore makes it possible to carry out the various steps needed for the anode-frame lifting operation, namely:

deposition of the lifting frame on the top of the cell in question:

application of a pressing force on the anode rods (12) against the anode frame so as to maintain electrical continuity;

gripping of the anode rods by the gripping modules;

unclamping of the connectors, ensuring that the anode rods are fastened to the anode frame;

raising of the anode frame;

reclamping of the said connectors onto the rods;

stopping of the anode-rod clamping and gripping function;

removal of the lifting beam.

The lifting beam according to the invention furthermore has a certain degree of modularity, thus making it capable of being fitted to various cell morphologies. As a result, the gripping and holding members (5) are adjustable in terms of fastening to the constituent cross-member (1) of the lifting beam.

In operating mode, the said beam should therefore be configured according to the type of cell, and especially according to the spacing between the anode rods (12), this configuration being aimed essentially at positioning the said gripping members on the cross-member (1) according to this spacing.

Advantageously, it is advisable to blow the anode rod on the rear anode frame so as to clean the frame of any alumina which might be deposited thereon and which, in this situation, would constitute an insulating film to the detriment of the proper electrical operation of the cell.

At the same time, it is also advisable to strike the rod before clamping, so as to make good electrical contact between anode rod and anode frame.

At the same time, given the fact that the front face of the rod is free, it is possible to fit onto the lifting beam a system for mechanically clamping and unclamping the connectors, thus making it possible for the frame lifting operation to be made automatic and without any risk or physical harm for the operators.

Furthermore, and as may be seen in FIG. 3, the gripping modules are also capable of having a pivoting motion in the plane of the anode rods.

For this purpose, they have two pivoting points, (18) in the upper part and (20) in the intermediate part respectively, the corresponding pivot pins being fastened to the constituent framework of the members (5). While the pivoting system (18) is free of any stress, the system (20) is however adjustable by means of springs and screws in such a way as to allow a lateral deflection of around 20 to 30 mm. This allows a greater tolerance on fitting the gripping modules at the anode rods.

Finally, it is possible to install a single pressing module for two anode-rod gripping modules, which makes it possible to adapt the height requirement of the lifting beam to its environment, independently of the economic benefit of such a configuration.

The entire benefit of such an anode-frame lifting device will consequently be appreciated. This is because, apart from the relative simplicity of the construction, and correspondingly of the implementation of such a device, the fitting of double-acting actuators, with a positive effect produced by the spring, increases the operating safety of the device.

1. Device for lifting the anode frame of an electrolysis cell for the production of aluminium, characterized in that it comprises:
a horizontal cross-member (1) intended to be positioned above the cell in question;
a plurality of members for gripping and holding (5) the anode rods (12) against the anode frame, comprising:
a pressing module, pivoted (4) at its upper end to the said cross-member, so as to be able to undergo a pivoting movement with respect to the said cross-member, in such a way as to move away from the plane containing the anode rods on the same side of the cell and intended to keep the anode rods against the anode frame; and
a gripping module, fastened to the pressing module and intended to ensure actual gripping of an anode rod.

2. Device for lifting the anode frame of an electrolysis cell according to claim 1, characterized in that the gripping and holding members (5) are placed on each side of the cell, and therefore on each side of the cross-member (1).

3. Device for lifting the anode frame of an electrolysis cell according to either of claims 1 and 2, characterized in that the gripping and holding members (5) are fixed to the cross-member with a spacing depending on the standard separation between the anode rods (12) of a cell-line in question.

4. Device for lifting the anode frame of an electrolysis cell according to one of claims 1 to 3, characterized in that the pivoting movement of the pressing modules is provided by means of an activator (9), in the absence of the activation of which a return spring (7) causes the said pressing modules to be pressed against the cross-member, that is to say precluding any pivoting movement, and consequently causing the anode rods to be pressed against the anode frame.

5. Device for lifting the anode frame of an electrolysis cell according to claim 4, characterized in that the activator is an air cylinder (9) of the soft pancake type.

6. Device for lifting the anode frame of an electrolysis cell according to one of claims 1 to 5, characterized in that the gripping module consists of a clamp (13) located at the lower end of the gripping and holding member (5), the said clamp being opened by the action of an activator (19), in the absence of the activation of which a spring (17) causes it to close onto the said anode rod (12).

7. Device for lifting the anode frame of an electrolysis cell according to claim 6, characterized in that the activator is an air cylinder (19) of the trilobate soft pancake type.

8. Device for lifting the anode frame of an electrolysis cell according to one of claims 1 to 7, characterized in that the gripping module is capable of undergoing pivoting movements in the plane of the anode rods (12) on the same side of the cell.

9. Device for lifting the anode frame of an electrolysis cell according to claim 8, characterized in that the gripping module has two pivoting points, in the upper part (18) and in the intermediate part (20) respectively, because of the corresponding pivot pins being fastened to the constituent framework of the members (5) in such a way as to allow a lateral deflection of the gripping module and thus to have a greater tolerance on fitting the said module at the anode rods.

10. Device for lifting the anode frame of an electrolysis cell according to claim 9, characterized in that the upper pivoting system (18) is free, that is to say free of any stress, and in that the intermediate pivoting system (20) is adjustable by means of springs and screws.

11. Device for lifting the anode frame of an electrolysis cell according to one of claims 1 to 10, characterized in that each pressing module is associated with two anode-rod gripping modules.
